(19) United States
(12) Patent Application Publication
(10) Pub. No.: US 2005/0116966 A1
(43) Pub. Date: Jun. 2, 2005

(54) Web imaging serving technology

(76) Inventors: James J. Graham, Fort Collins, CO (US); Dallen Campbell, Loveland, CO (US); Craig D. Harrison, Fort Collins, CO (US)

Correspondence Address: COCHRAN FREUND & YOUNG LLC, 2026 CARIBOU DR, SUITE 200, FORT COLLINS, CO, 80525, US

(21) Appl. No.: 10/408,757

(22) Filed: Apr. 3, 2003

Related U.S. Application Data
(60) Provisional application No. 60/370,083, filed on Apr. 4, 2002.

(51) Int. Cl. G09G 5/00

(52) U.S. Cl. 345/661

(57) ABSTRACT

Disclosed is a method for displaying sections of large images such as maps. A grid is placed over an image database that references the various files contained in the database. When an area is identified for a query, the cells of the grid refer only to those files to be searched that pertain directly to the query. Further, the grid reference system also allows panning and zooming of the image to be dynamic and virtually instantaneous without limitation to the bandwidth of an Internet connection.

### CROSS REFERENCE TO RELATED APPLICATIONS

This application is based upon and claims the benefit of U.S. provisional application No. 60/370,083, entitled “Web Imaging Serving Technology,” filed Apr. 4, 2002 by James J. Graham and Dallen Campbell, the entire disclosure of which is herein specifically incorporated by reference for all that it discloses and teaches.

### BACKGROUND OF THE INVENTION

a. Field of the Invention The present invention pertains generally to large imaging and specifically to the storage, retrieval, and display of large images.
b. Description of the Background Maps and other large image databases are being used on the Internet for various purposes. These databases are enormous in size and may consist of literally thousands of individual files. Searches and other queries of these databases may be very time consuming and computationally intensive.

The display of portions of large image databases on the Internet using web browsers can also be tedious and slow due to the considerable bandwidth required for transmitting images over the Internet. Once the image is displayed on the user's web browser, the user often would like to zoom and pan the image to view other sections or more detailed sections of the image. When the zoom and pan functions are very slow, users may be frustrated with the performance and either feel like they are wasting their time, not utilize the full functionality of the image, or abandon the use of the image.

It would therefore be advantageous to provide a system and method for quickly retrieving and displaying portions of a large image database. It would be further advantageous to provide a method for dynamically zooming and panning the retrieved and displayed databases quickly and efficiently while not being limited to the bandwidth restrictions of a specific Internet connection.

### SUMMARY OF THE INVENTION

The present invention overcomes the disadvantages and limitations of the prior art by providing a grid that is overlaid upon the image database. The grid provides a quick method for an image database to search for only the appropriate files necessary to generate an image, thereby eliminating as much unnecessary processing time as possible. Further, the grid may be used in a client applet or plug in to simplify requests for additional image data as well as very quick zoom and pan capabilities that are not limited by bandwidth restrictions.

The present invention may therefore comprise a method for creating a small image from a large image stored in a plurality of files comprising: creating a grid on top of the large image area, the grid being comprised of cells, each of the cells having references to files of the large image, the files being the particular files relating to the area of the large image covered by the particular cell; receiving a request for the small image, the small image being at least a portion of the large image; mapping the request on top of the grid; determining which particular cells of the cells are covered at least in part by the request; retrieving the files associated with all of the particular cells; and creating the small image based on the request from the retrieved files.

The present invention may further comprise a method of zooming of an image displayed on a web browser comprising: generating a grid, the grid covering a large image; generating an image by a server, the image being composed of a plurality of tiles, the tiles being related to positions on the grid, the image further being a subset of the large image; transmitting the grid and the tiles to a client; receiving the grid and the tiles by the client; displaying the image based on the grid and the tiles; receiving a command to zoom the image, the command being from a user, the command being received by the client; generating a temporary image by transforming at least a portion of at least one of the tiles to the scale requested by the user, the generating being performed by the client; displaying the temporary image by the client; requesting updated tiles for the temporary image based upon the grid; generating the tiles by the server, the tiles being of the scale requested by the user; receiving the tiles by the client; and displaying the tiles on the image by the client.

The present invention may further comprise a server for the generation of images from a large image database comprising: a large image database, the large image being stored in a plurality of files, each file covering a section of the total area covered by the large image; a grid, the grid having been defined to cover the total area covered by the large image, the grid being composed of cells, each cell being associated with the particular files covered by the area of each cell; and a server adapted to receive an image request and to overlay the image request on top of the grid to determine the individual cells covered at least in part by the request, the server further adapted to identify the files associated with the individual cells and use the files for the creation of the requested images.

The advantages of the present invention are that sections of enormously large image databases may be quickly and rapidly generated without time consuming searching techniques. Further, when the techniques are applied to a client/server environment, very fast panning and zooming techniques may be used.

### BRIEF DESCRIPTION OF THE DRAWINGS

In the drawings,

FIG. 1 is an illustration of an embodiment of the present invention wherein a large image has a grid overlaid thereupon.

FIG. 2 is an illustration of an embodiment of a method of the present invention for quickly generating an image from a large image database using the grid illustrated in FIG. 1.

FIG. 3 is an illustration of an embodiment of the present invention wherein an image is requested and displayed by a web browser.

FIG. 4 is an illustration of an alternative embodiment of the present invention of the configuration shown in FIG. 3 wherein an applet or plug-in is used.

FIG. 5 is an illustration of an embodiment of the present invention wherein a zoom command performed by an applet or plug in.

FIG. 6 is a workflow diagram of an embodiment of the present invention of a method for dynamically zooming an image using an applet or plug in.

FIG. 7 is an illustration of a technique for the simplification of the retrieval of image data of various scales known as pyramiding.

FIG. 8 is a workflow of an embodiment of the present invention for the creation of an image using an applet or plug in such as in the embodiment of FIG. 4.

FIG. 9 is a workflow of an embodiment of the present invention for the panning of an image using an applet or plug in such as in the embodiment of FIG. 4.

FIG. 10 is a workflow of an embodiment of the present invention for the zooming of an image using an applet or plug in such as in the embodiment of FIG. 4.

### DETAILED DESCRIPTION OF THE INVENTION

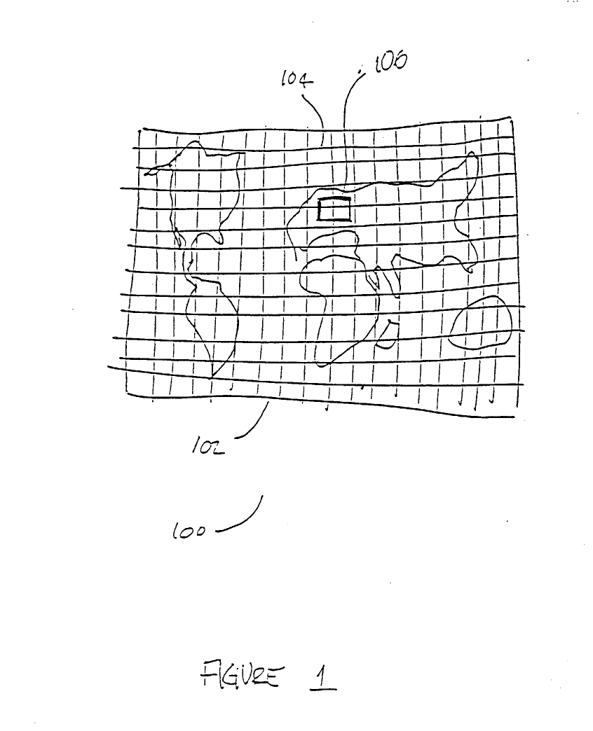

FIG. 1 illustrates an embodiment 100 of the present invention wherein a large image 102 has a grid 104 overlaid thereupon. The boundary 106 of a requested image is shown on the image 102. The grid 104 allows a fast and efficient method of determining which specific sections of the image database needs to be analyzed and retrieved to create the requested image.

The large image 102 may be a very large image database, such as a terrestrial map. Such maps are commonly terabytes in size and are time consuming to search. Further, the maps may be a compilation of many individual files. For example, an image database of a few terabytes in size may be comprised of 1000 or more individual files. Each individual file may comprise a section of the entire large image 102. When a requested area of the large image is requested, portions of several files may be required to generate the requested image.

The grid 104 is overlaid on the large image 102. Each section of the grid 104 covers a designated area of the large image 102. Further, each section of the grid 104 may be related to one or more of the several files that make up the entire database that encompasses the large image 102.

The boundary 106 is an area of the large image 102 that is to be retrieved, rendered, and displayed. The boundary 106 may overlap one or more sections of grid 104. By determining which sections of grid 104 overlap the boundary 106, a limited number of files may be selected from which to generate the requested image. From this limited set of files, a very quick and efficient search of the files may be performed to identify and retrieve the necessary data to create the requested image.

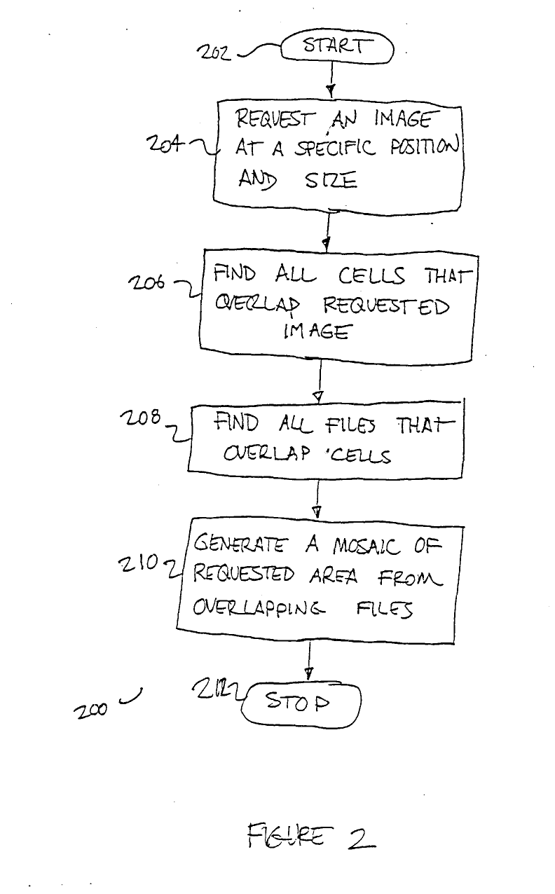

FIG. 2 illustrates an embodiment 200 of a method for quickly generating an image from a large image database using the grid illustrated in FIG. 1. After the method 200 is started 202, a request for a section of the image database is made 204, the cells that overlap the requested section is determined 206, the corresponding files are determined 208, and an image is generated from the files 210 before the method is stopped 212.

The request for a section of the image database 204 may comprise a position and size of the requested image. Further, the request may contain other parameters that may be used to determine the post processing or other manipulation of the requested image. Such parameters may include the overall size and shape of the final image, special characteristics that relate to the color, look, and feel of the image, and other parameters as may be required by any post processing of the image.

After the request is made in block 204, all of the cells that overlap the requested area are determined 206. The cells are determined by comparison of the coordinates of the requested image. Each cell contains references to one or more image files that make up the large image database.

When the cells are defined, the image files contained in those cells may then be determined 208. The image files may be the actual files that contain portions of the image that is requested.

When the group of image files are collected, a mosaic of the requested area is generated 210. The mosaic refers to an image that is a collection of one or more portions of the image files. The mosaic may be ‘stitched’ together from several files to generate the requested image. In some cases, the images may be projected onto a different coordinate system, transformed, or otherwise be manipulated to create the requested image. In addition, post processing of the image, including changing the look and feel of the image, or any other image processing may happen at this step. The completed image may be ready for display and the process is stopped 212.

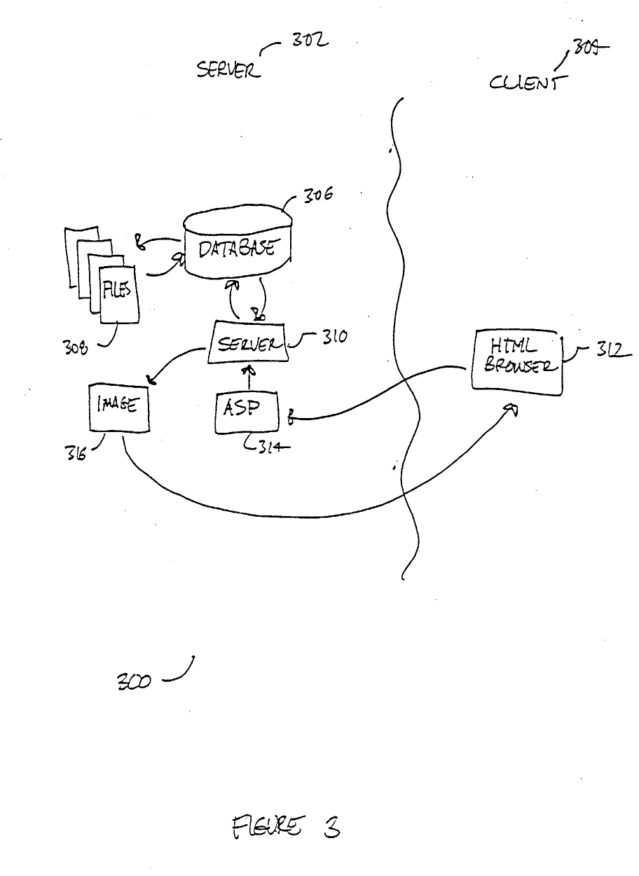

FIG. 3 illustrates an embodiment 300 wherein an image is requested and displayed by a web browser. The two major components are the server 302 and the client 304. The elements of the server 302 are a database 306, a set of image files 308, and a server program 310. The client 304 contains an HTML browser 312. The browser 312 sends a request to an active server page (ASP) request 314 to the server 310, which communicates with the database 306 to retrieve information to generate an image 316. The database 306 finds the necessary information from the files 308 and passes the information back to the server 310 for processing. The server 310 then generates an image 316 that is retrieved by the browser 312 for display.

The basic client/server configuration shown in the present figure is illustrative of a typical ASP web server. In this case, the embodiment is shown to generate an image on the fly. Such an embodiment may be used with the methodology described in FIGS. 1 and 2 to create and display images.

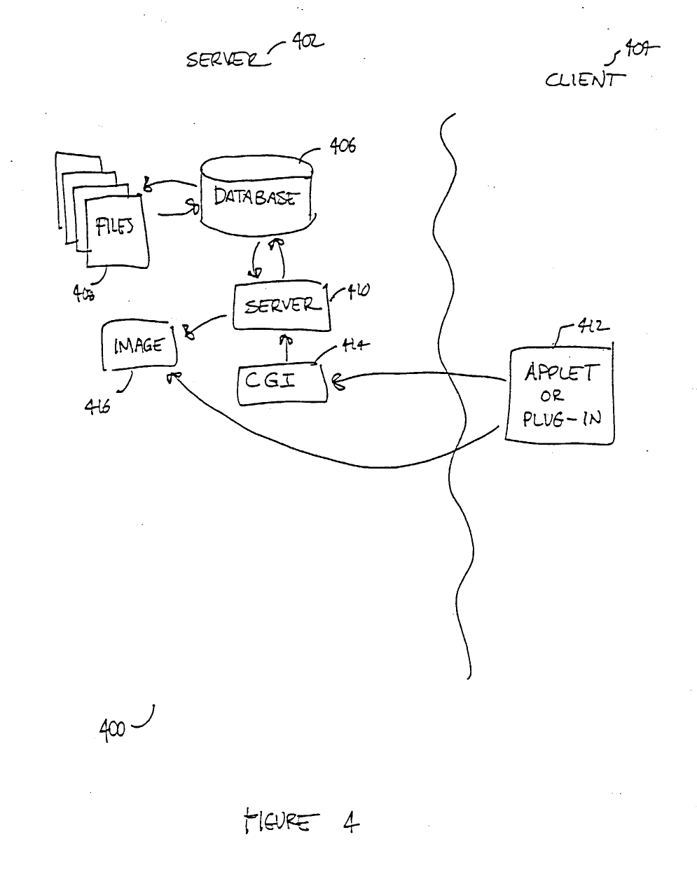

FIG. 4 illustrates an alternative embodiment 400 of the configuration shown in FIG. 3 wherein an applet or plug-in is used. The two major components are the server 402 and the client 404. The elements of the server 402 are a database 406, a set of image files 408, and a server program 410. The client 404 contains an HTML browser 412 that contains either an applet or a plug-in. The browser 412 sends a request to the common gateway interface (CGI) 414 that is executed by the server 410, which communicates with the database 406 to retrieve information to generate an image 416. The database 406 finds the necessary information from the files 408 and passes the information back to the server 410 for processing. The server 410 then generates an image 416 that is retrieved by the browser 412 for display.

The present figure is different from FIG. 3 only in that an applet or plug in is used to make direct calls to the CGI interface of the server. This embodiment is further different in that the applet or plug in is able to perform additional functions that cannot be performed in the embodiment 300 shown in FIG. 3. Such feature will now be described.

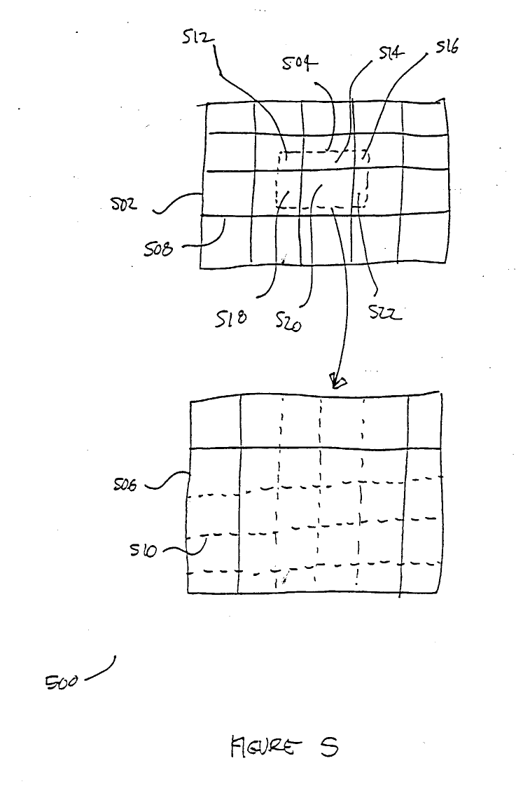

FIG. 5 illustrates an embodiment 500 of a zoom command performed by an applet or plug in. A first image 502 may be zoomed in to the dashed area 504, which is then displayed in the full area of the image, as shown the second image 506.

The first image 502 may be comprised of tiles, or small pictures that are placed next to each other to create a single image. The tiles are placed next to each other so that no border is visible and the user sees a single picture. The grid 508 represents a set of tiles used to create the first image 502. When an image is panned, the tiles may be shifted over and only the new tiles required to create the image may need to be transferred from the server. In this manner, the panning action may be done quickly since only a small portion of the image needs to be updated from the server.

Image data tends to be large and consume a large amount of bandwidth during the transmission of the data from the server to the client. The bandwidth of the communications between the server and client is the largest contributor to performance of what the user sees and experiences. If a user has a dial up connection and the performance is very slow, the user may not enjoy having to wait for the images to appear on the screen and become frustrated.

When the image is zoomed instead of panned, the image data needs to be updated, since the level of detail is not available. In the present invention, the lower resolution tiles of the zoomed area may be enlarged with the level of detail that is available in the lower resolution tiles, then the higher resolution tiles may be added into the image as they become available to the applet or plug in. The applet or plug in may create a dynamically zoomed image using the available information and update the image as the updated information is available.

The advantage of the present invention is that the appearance of smooth, dynamic zooming is available to the user without a complex and time consuming process of requesting a new image and having that image sent to the client. Further, the smooth dynamic zooming is not dependent on the bandwidth limitations for the user to have instantaneous input and response of the zooming.

In one embodiment of the present invention, a mouse button, for example, may be clicked and dragged to dynamically zoom in and out of an image.

The grid 510 of the second, zoomed image represents tiles that create the higher resolution, or zoomed-in image. After the user indicates the zoomed in area, the portions oftiles 512, 514, 516, 518, 520, and 522 are enlarged in the applet or plug in and displayed on the screen. Such an enlargement is done locally by the applet or plug in and does not require any communication over a network that may limit performance.

After the local zooming is performed, the individual detailed tiles represented by grid 510 may be requested and inserted into the image on the screen. The updating of the image may be limited by the bandwidth available for communication between the client and server. However, the user experience is one of seeing a zoom occur very fast and dynamically.

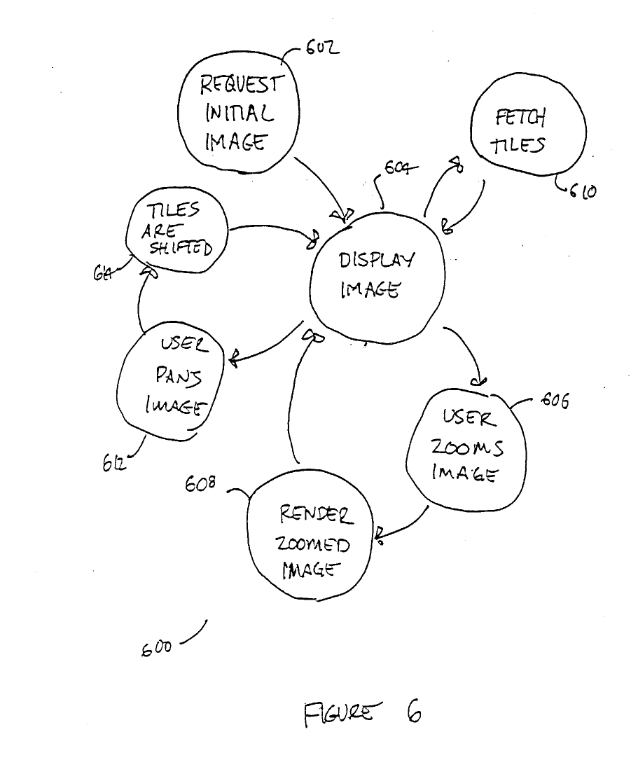

FIG. 6 illustrates a workflow diagram of an embodiment 600 of a method for dynamically zooming an image using an applet or plug in. The initial image is requested 602 and displayed 604. When a user executes a zoom 606, a rendered zoomed image is created 608 and immediately displayed 604. As the image is displayed 604, tiles may be fetched 610 to update areas of the image. When a user pans an image 612, the tiles are shifted in the direction of the pan, displayed 604, and the missing tiles are fetched 610. All of the functions illustrated in the embodiment 600 are performed by the applet or plug in, with the exception of the fetching files 610. The files are fetched through the Internet or other communication network from a server computer.

The initial image that is requested is transferred in its entirety from the server to the applet or plug in and displayed. The transfer of the first image may come from the server to the client in its entirety before it is displayed, or the image may come over in tiles. In the latter case, the requested image may be displayed as a blank area of the screen and individual tiles are fetched 610 as the tiles are retrieved and displayed one at a time.

When the user zooms the image, the user may do so using a slider bar, a mouse movement, a press of a key, or any other method for inputting to a computer. The image may zoom in certain steps, such as from one map resolution to another, or the image may zoom smoothly and dynamically.

The rendering of the zoomed image 608 may be performed locally by the applet or plug in. The rendering may occur by stretching or enlarging an existing tile or set of tiles to fill the available space. Rendering may be performed by software routines that quickly create a new image. In some embodiments, specialized hardware may be used to render the new image.

When the rendered image is completed, it is immediately displayed. The individual tiles that make up the new image may then be requested from the server and inserted into the image as the tiles are available.

When the user pans the image 612, the tiles that make up the image may be shifted 614 and displayed 604. The new tiles necessary to complete the image may then be fetched 610. In some cases, the applet or plug in may keep track of all the images and tiles that have been requested and keep some of the tiles in memory. If the tiles are already in memory, those tiles may be instantly fetched without having to be retrieved from the server.

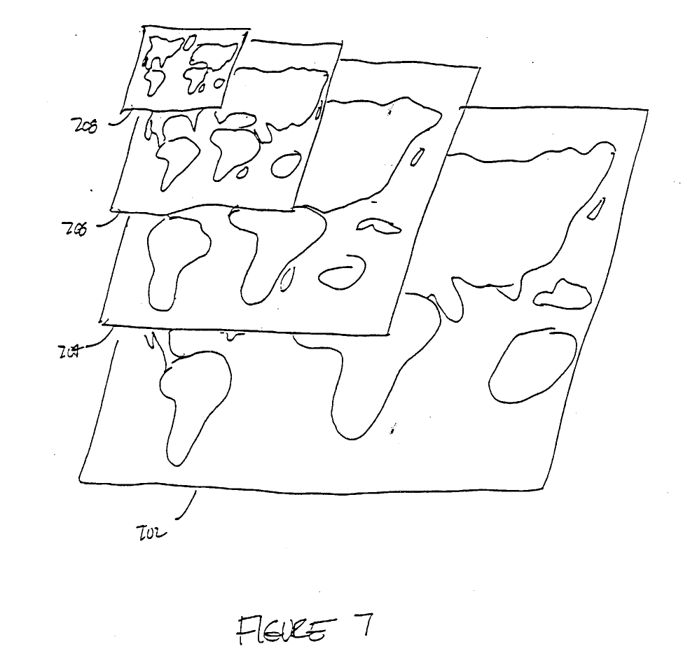

FIG. 7 illustrates a technique for the simplification of the retrieval of image data of various scales known as pyramiding. The image 702 represents the largest and most detailed rendition of an image database. The images 704, 706, and 708 represent successively smaller and less detailed versions of the same image database as image 702. For image requests at a high level, that is zoomed out, the images may be created from the image database 708, the least detailed database. For example, the large database 702 may be a 1:18,000 scale image, whereas images 704, 706, and 708 may be 1:24,000, 1:50,000 and 1:100,000 scale respectively. The images 704, 706, and 708 may be generated from the large image 704, or may be separately generated images.

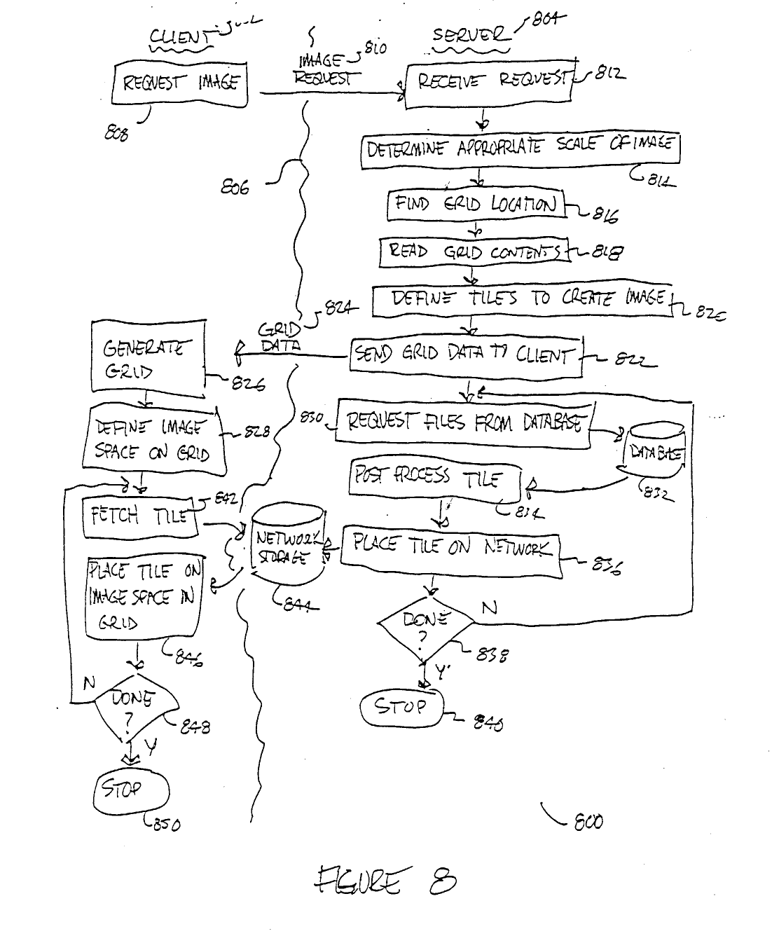

FIG. 8 illustrates a workflow of an embodiment 800 of the present invention for the creation of an image using an applet or plug in such as in embodiment 400 of FIG. 4. The processes for the client 802 and server 804 are shown separated by the line 806. Communications across line 806 may typically be through the Internet or other communications network.

The client 802 makes an image request 808 that is transferred 810 to the server 804. The server 804 receives the image request 812, determines the appropriate scale of the image 814, finds the grid location 816, reads the grid contents 818, defines the tiles that creates the image 820, and sends the grid data 822 to the client 802. The grid data 824 is used by the client 802 to generate a grid 826, and define an image space on the grid 828. Meanwhile, the server 804 requests the necessary files 830 from the database 832 and post processes the tile 834. The tile is placed 836 on the network 844. If more tiles need to be processed 838, the sequence is resumed, if not, the server 804 process stops 840. As each tile is placed on the network storage 844, the client fetches the tile 842 and places the tile on the image space on the grid 846. If more tiles need to be processed 848, the sequence is continued, if not, the process stops 850.

The basic process is to make a request for data from the server by the client. The server may send two types of data to the client. The first piece of data may be a grid or portion of a grid similar to the grid 104 illustrated in embodiment 100 of FIG. 1. The grid serves as a common reference point for efficient communication of image tiles between the client 802 and server 804. The second set of data contains the individual tiles that are to be displayed on the grid. The image area is the place on the grid where the tiles are to be displayed. As the image is subsequently panned and zoomed, the client and sever may communicate by requesting and creating only the individual tiles necessary to complete the entire image that is required. The use of the grid allows the server to only access the necessary files that comprise the gigantic images of the database. This makes the searching and processing of the image database much less cumbersome, time consuming, and hence, less costly.

The image request 808 may be the initial request by a web browser. In such a state, the web browser may be running an applet that has not received any data. After the initial request, such as when the user wishes to view another section of the image, the client 802 may request only specific tiles.

The first action of the server 804 may be to determine the appropriate scale of the image to be created 814. This may allow the server 804 to use a smaller, more efficient database to search and subsequently create the necessary tiles.

The actions of determining the grid locations 816 and reading the grid contents 818 enable the server 804 to identify the tiles necessary to create the image 820. In steps 816, 818, and 820, the grid is analyzed and the requested image is mapped out in terms of the tiles required to construct the image. This data is sent to the client 822 so that the client 804 can generate a matching grid on which to overlay the specific tiles. The common use of the grid on both the client 802 and server 804 allow both computers to communicate using tile or grid identifiers. Such a communication minimizes the computational time required on both sides to generate subsequent requests, identify the specific tiles that need to be generated, and to place the tiles in the correct position to generate new images.

The client 802 executes the process steps of generating the grid 826 and defining the image space on the grid 828. These steps give the client a framework for performing tasks such as zooming and panning as will be discussed later. The steps 826 and 828 may be performed simultaneously while the server 804 is generating the required tiles to create the requested image.

The server 804 performs the steps of requesting files from the database 830, post processing the tile 834, and placing the tile on the network 836. The files retrieved from the database may be large files from which the server 804 may create a smaller image segment. In some cases, the tile may be spread over two or more files, so that the server 804 may have to take several sections of several files and consolidate the sections into a single tile. When the server 804 places the tile on the network 836, the server 804 may send a message to the client 802 with the file locator information so that the client 802 may retrieve the tile. The network storage 844 may be a disk drive or other computer system that is commonly accessible for both the client 802 and server 804. Such a storage device may be a server or disk array on the Internet.

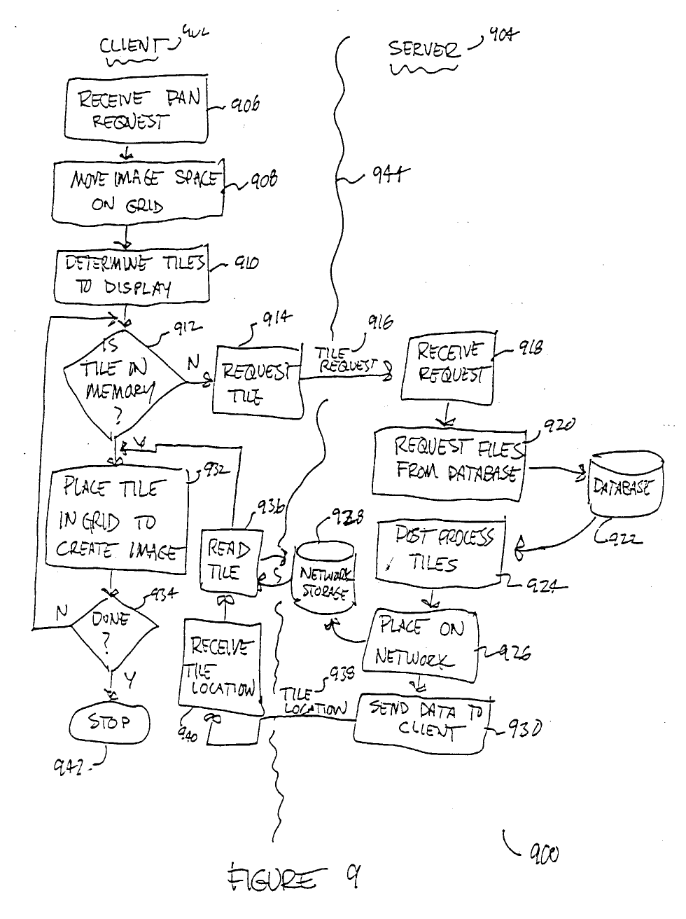

FIG. 9 illustrates a workflow of an embodiment 900 of the present invention for the panning of an image using an applet or plug in such as in embodiment 400 of FIG. 4. The embodiment 900 uses similar processes and procedures as that of embodiment 800 of FIG. 8. The processes for the client 902 and server 904 are shown separated by the line 944. Communications across line 944 may typically be through the Internet or other communications network.

The client 902 receives a pan request 906, moves the image space on the grid 908, and determines the tiles to display 910. The client 902 then checks to see if the tiles are in local memory 912. If the tile is in local memory, they are placed in the image are of the grid to create the image 932 and the next tile is processed 934. If the tile is not in local memory 912, a request for a tile is made 914, transferred 914 to the sever 904 and received 918. The server 904 requests files 920 from the database 922, and post processes the tile 924. The tile is placed 926 on the network storage 928 and data is sent to the client 930. The tile location 938 is sent to the client 902, received 940, and the tile is read 936 from the network storage 928. The new tile is then placed in the grid 932. The process continues 934 until all the tiles are completed and the process stops 942. The tile location 938 may refer to the network address of the file containing the tile location.

The client 902 has the image defined on the grid, which corresponds to the grid used by the server for determining the appropriate files to retrieve to generate each tile. The image is defined as the area of the grid that is to be displayed. When the request to pan the image, the area of the grid that is to be displayed is correspondingly changed. The client 902 may then analyze the displayed area to determine if it has all of the necessary tiles or if new tiles need to be retrieved from the server 904. Any new tiles are requested using the notation of the grid so that the server 904 is not burdened with the task of looking up the grid locations to determine the necessary files to search.

One of the advantages of the present embodiment is that a minimum of bandwidth and computational time is necessary to complete a task. Further, if a tile is loaded into local memory on the client, the tile may be instantly displayed.

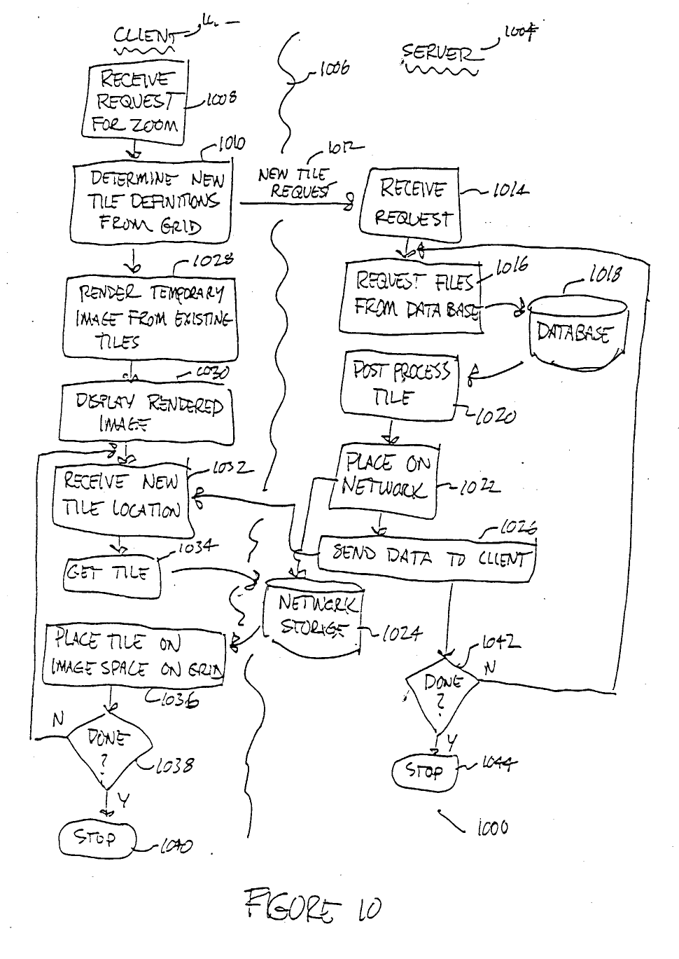

FIG. 10 illustrates a workflow of an embodiment 1000 of the present invention for the creation of an image using an applet or plug in such as in embodiment 400 of FIG. 4. The processes for the client 1002 and server 1004 are shown separated by the line 1006. Communications across line 1006 may typically be through the Internet or other communications network.

The client 1002 receives a request to zoom 1008 and determines the new tile definitions from the grid 1010. Any new tiles that need to be created are requested 1012 and received 1014 by the server 1004. As with the embodiments 800 and 900, the server requests files 1016 from the database 1018, post processes a tile 1020, places the tile on the network 1022, notifies the client 1024, and repeats the process 1042 for each tile until completed 1044. The client 1002 renders a temporary image using the existing tiles 1028 and displays the temporary rendered image 1030. As the client 1002 receives the location for each new tile 1032, the tile is retrieved 1034 from the network storage 1024 and placed in the image space on the grid 1036. The client process is continued 1038 until all the tiles are retrieved and displayed, after which the process is stopped 1040.

The embodiment 1000 allows a user to quickly zoom without having to stop and wait for a new image to be generated and transmitted. By using the existing tiles when zooming in, the client 1002 may quickly display an image that the user requests. As quickly as the tiles are generated and transmitted to the client 1002, the zoomed in image is updated so that the user may see the detailed image that they desire. Since the existing tiles may be zoomed with only local processing required, the zoom may be smooth and dynamic. This effect allows the user to select the level of detail they wish to view without bandwidth or data availability restrictions, then allow the detailed image to come up on the screen as it is available. In general, during a dynamic zoom or pan operation, the user is not interested in the minute details of an image but only in moving the image to the approximate location so that the details of the image may be studied with more carefulness. Thusly, the lower resolution images that are temporarily displayed during the zoom operation may not be a detriment to the functionality of the image viewing, so long as the image may be updated with details with reasonable quickness.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for creating a small image from a large image stored in a plurality of files comprising:
creating a grid on top of the large image area, said grid being comprised of cells, each of said cells having references to files of said large image, said files being the particular files relating to the area of said large image covered by the particular cell;
receiving a request for said small image, said small image being at least a portion of said large image;
mapping said request on top of said grid;
determining which particular cells of said cells are covered at least in part by said request;
retrieving the files associated with all of said particular cells; and
creating said small image based on said request from said retrieved files.

2. A method of zooming of an image displayed on a web browser comprising:
generating a grid, said grid covering a large image;
generating an image by a server, said image being composed of a plurality of tiles, said tiles being related to positions on said grid, said image further being a subset of said large image;
transmitting said grid and said tiles to a client;
receiving said grid and said tiles by said client;
displaying said image based on said grid and said tiles;
receiving a command to zoom said image, said command being from a user, said command being received by said client;
generating a temporary image by transforming at least a portion of at least one of said tiles to the scale requested by said user, said generating being performed by said client;
displaying said temporary image by said client;
requesting updated tiles for said temporary image based upon said grid;
generating said tiles by said server, said tiles being of said scale requested by said user;
receiving said tiles by said client; and
displaying said tiles on said image by said client.

3. A server for the generation of images from a large image database comprising:
a large image database, said large image being stored in a plurality of files, each file covering a section of the total area covered by said large image;
a grid, said grid having been defined to cover said total area covered by said large image, said grid being composed of cells, each cell being associated with the particular files covered by the area of each cell; and
a server adapted to receive an image request and to overlay said image request on top of said grid to determine the individual cells covered at least in part by said request, said server further adapted to identify the files associated with said individual cells and use said files for the creation of said requested images.
